(19) United States
(12) Patent Application Publication
(10) Pub. No.: US 2007/0233867 A1
(43) Pub. Date: Oct. 4, 2007

(54) Method and apparatus for preserving MAC addresses across a reboot

(76) Inventors: Narasimhan Ganapathiraman, San Jose, CA (US); Sanjay Khanna, Fremont, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/393,375

(22) Filed: Mar. 28, 2006

(51) Int. Cl. G06F 15/173

(52) U.S. Cl. 709/226

(57) ABSTRACT

An example network node includes multiple line cards that learn Medium Access Control (MAC) addresses in a distributed manner. In an event a software upgrade is to occur, which requires a processor having the MAC addresses on the line cards to reboot, the line cards transfer the learned MAC addresses to a supervisory control card that normally does not know the MAC addresses. After the reboot, the line cards retrieve the MAC addresses, saving the line cards from having to relearn the MAC addresses.

### TECHNICAL FIELD

This invention relates to the field of communications. In particular, this invention is drawn to methods and apparatus for modifying a layered protocol communication apparatus including software modifications associated with different levels of the layered protocol communication apparatus.

### BACKGROUND OF THE INVENTION

Communication networks are used to carry a wide variety of data. Typically, a communication network includes a number of interconnected nodes. Communication between source and destination is accomplished by routing data from a source through the communication network to a destination. Such a network, for example, might carry voice communications, financial transaction data, real-time data, etc., not all of which require the same level of performance from the network.

One metric for rating a communication network is the availability of the network. The network might be used, for example, to communicate data associated with different classes of service such as “first available”, business data, priority data, or real-time data which place different constraints on the requirements for the delivery of the data including the timeframe within which it will be delivered.

Disruption to the network can be very costly. The revenue stream for many businesses is highly dependent upon the availability of the network. The network service provider frequently is under contract to guarantee certain levels of availability to customers and may incur significant financial liability in the event of disruption.

In the interest of ensuring the continued availability of the network or the avoidance of an event that might lead to catastrophic disruption, maintenance is performed on the nodes. Maintenance may also be required to ensure that the nodes support various communication protocols as they evolve over time.

The maintenance process itself can contribute to disruption of network availability. One type of maintenance is a software upgrade. Although nodes with redundant capabilities may avoid the disruption of traffic during the upgrade, providing such redundancies for every node may either be financially or operationally impractical.

Non-redundant elements in the upgrade path represent a significant risk to uninterrupted traffic flow. One approach for performing a software upgrade on non-redundant elements is to physically remove modules with the dated software and replace them with modules for which the software has been updated. This undesirably disrupts all traffic being handled by the module prior to removal.

### SUMMARY OF THE INVENTION

An example embodiment of the invention may be a method that preserves network addresses in a network node across a reboot. The method includes learning network addresses (e.g., Medium Access Control (MAC) addresses), associated with sources and destinations of network communications, in distributed components of a network node on a network path between the sources and destinations. The network addresses are lost by the distributed components in an event of a reboot of the distributed components. The method transfers the network addresses from the distributed components to at least one other component, uninvolved with learning the network addresses, prior to a reboot. The method causes the distributed components to reboot and retrieves the network addresses from the at least one other component to the distributed component to preserve the network addresses across the reboot.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates one embodiment of a layered protocol model for a communications network.

FIG. 2 illustrates one embodiment of an alternative layered protocol model for a communications network.

FIG. 3 illustrates one embodiment of a communications network component implementing a layered protocol.

FIG. 4 illustrates a software download status prior to performing an upgrade of the software for one element associated with an upper level layer of a layered protocol communication apparatus.

FIG. 5 illustrates the layered protocol communication apparatus after the software upgrade of the element associated with the upper level layer.

FIG. 6 illustrates transfer of layer functionality from processors at one hierarchical level to a processor at a higher hierarchical level.

FIG. 7 illustrates the apparatus after the software upgrade of the elements normally associated with the second layer.

FIG. 8 illustrates the transfer of layer functionality from the processor at the higher hierarchical level to the processors normally associated with the layer.

FIG. 9 illustrates reconfiguring the low level hardware handling the data traffic.

FIG. 10 illustrates the swap in active/standby status for redundant elements at a higher level.

FIG. 11 illustrates the layered protocol communication apparatus after the software upgrade of another higher level element.

FIG. 12 illustrates one embodiment of process of upgrading the software of a communications node.

FIG. 13 illustrates one embodiment of a preparation phase of the software upgrade process.

FIG. 14 illustrates one embodiment of the beginning of the execution phase of the software upgrade process.

FIG. 15 illustrates one embodiment of transferring a control plane between processors at different levels of the element hierarchy.

FIG. 16 illustrates one embodiment of transferring layer functionality between processors at different levels of the element hierarchy.

FIG. 17 illustrates one embodiment of re-configuring low-level hardware handling the data traffic.

FIG. 18 illustrates an alternative embodiment of re-configuring low-level hardware handling the data traffic.

FIG. 19 illustrates one embodiment of the completion of the execution phase of the software upgrade process.

FIG. 20 illustrates a network in which an example embodiment of the invention is employed.

FIG. 21 illustrates a node transferring network addresses (e.g., MAC addresses) from a processor to go through a reboot to a processor operating at a different layer.

FIG. 22 illustrates the rebooted processor retrieving the transferred network addresses.

FIG. 23A illustrates example multiple units in the processor being rebooted that is used to preserve the network addresses across a reboot.

FIG. 23B illustrates example multiple units associated with the processor being rebooted that is used to preserve the network addresses across a reboot.

FIG. 24 illustrates a flow diagram of an example embodiment of preserving the network addresses.

### DETAILED DESCRIPTION OF THE INVENTION

A description of example embodiments of the invention follows.

Communication networks frequently rely on protocol layering to simplify network designs. Protocol layering entails dividing the network design into functional layers and assigning protocols for each layer's tasks. The layers represent levels of abstraction for performing functions such as data handling and connection management. Within each layer, one or more physical entities implement its functionality.

For example, the functions of data delivery and connection management may be put into separate layers, and therefore separate protocols. Thus, one protocol is designed to perform data delivery, and another protocol performs connection management. The protocol for connection management is “layered” above the protocol handling data delivery. The data delivery protocol has no knowledge of connection management. Similarly, the connection management protocol is not concerned with data delivery. Abstraction through layering enables simplification of the various individual layers and protocols. The protocols can then be assembled into a useful whole. Protocol layering thus produces simple protocols, each with a few well-defined tasks. Individual protocols can also be removed, modified, or replaced as needed for particular applications.

Implementation of a given functional layer may occur within a single element or be distributed across multiple elements. Generally, however, the layering corresponds to a hardware or software hierarchy of elements. Each layer interacts directly only with the layer immediately beneath it, and provides facilities for use by the layer above it. The protocols enable an entity in one host to interact with a corresponding entity at the same layer in a remote host.

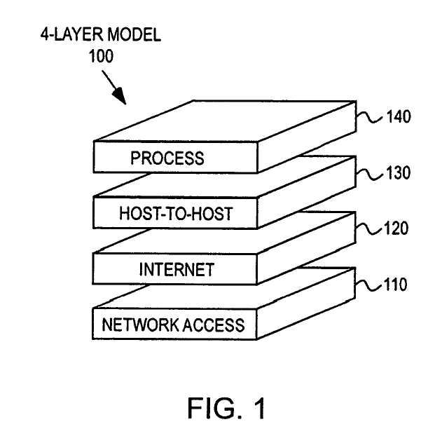

FIG. 1 illustrates one embodiment of a layered protocol design. This four layer model 100 was promulgated by the Defense Advanced Research Projects Agency's (DARPA) Internetwork Project for the Department of Defense in the 1970s. The DARPA Internetwork Project is the forerunner of the modern day ubiquitous Internet.

The network access layer 110 is responsible for dealing with the specific physical properties of the communications media. Different protocols may be used depending upon the type of physical network. The Internet layer 120 is responsible for source-to-destination routing of data across different physical networks.

The host-to-host layer 130 establishes connections between hosts and is responsible for session management, data re-transmission, flow control, etc. The process layer 140 is responsible for user-level functions such as mail delivery, file transfer, remote login, etc.

When traversing the layers or “stack” for a given model, the layers are typically numbered ascending from the bottom layer (i.e., Layer 1=network access layer) to the top layer (i.e., Layer 4=process layer). However, enumeration (e.g., numerical or alphabetical) is not intended to be limited to the reference from either the top or bottom unless the context demands it.

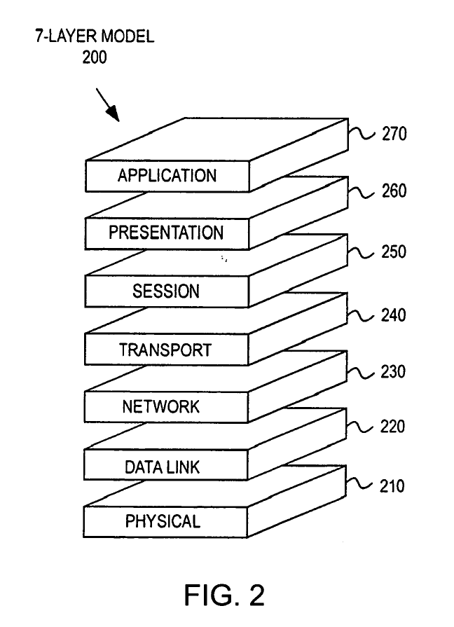

FIG. 2 illustrates an abstract networking model promulgated by the International Standard Organization. This model is also referred to as the basic reference model or the 7-layer model 200 of the Open Systems Interconnection network. Layers 210-230 are referred to as the “lower layers”. Layers 240-270 are referred to as the “upper layers”. The lower layers are concerned with moving packets of data from a source to a destination.

The physical layer 210 describes the physical properties of the communications media, as well as how the communicated signals should be interpreted. The data link layer 220 describes the logical organization (e.g., framing, addressing, etc.) of data transmitted on the media. The data link layer for example, handles frame synchronization

The network layer 230 defines the addressing and routing structure of the network. More generally, the network layer defines how data can be delivered between any two nodes in the network. Routing, forwarding, addressing, error handling, and packet sequencing are handled at this layer. This layer is responsible for establishing the virtual circuits when communicating between nodes of the network.

The transport layer 240 is responsible for end-to-end communication of the data between hosts or nodes. The transport layer, for example, performs a sequence check to ensure that all the packets associated with a file have been received. The session layer 250 establishes, manages, and terminates connections between applications. The session layer functions are often incorporated into another layer for implementation.

The presentation layer 260 describes the syntax of data being communicated. The presentation layer aids in the exchange of data between the application and the network. Where necessary, the data is translated to the syntax needed by the destination. Conversions between different floating point formats as well as encryption and decryption are handled by the presentation layer.

The application layer 270 identifies the hosts to be communicated with, user authentication, data syntax, quality of service, users, etc. The types of operations handled by the application layer include execution of remote jobs and opening, writing, reading, and closing files.

Different networks may define the protocol layers in other ways. Moreover, the protocol layers do not need to correspond to distinct layers in the hardware hierarchy. Implementation of a layer may be distributed across multiple levels in a hardware hierarchy. Alternatively, a single hardware element might handle more than one layer of the stack.

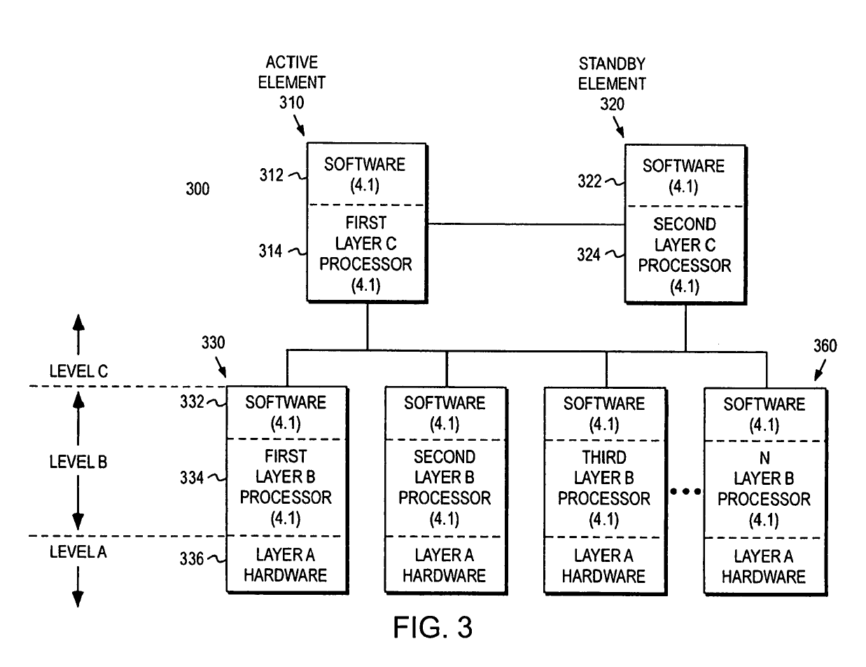

FIG. 3 illustrates one embodiment of an apparatus for implementing a layered protocol for a communications network. The apparatus may be one node 300 of a larger communications network. In one embodiment, for example, node 300 is a router. Node 300 includes a hierarchy of elements for implementing the various protocol layers. There is not necessarily a one-to-one correspondence between layers and elements handling those layers. Thus for example, element 330 handles Layers A and B, while element 310 handles Layer C and provides the interface to the physical media which connects apparatus 300 with other network nodes. The letter “A” indicates the lowest level in the layered protocol.

The apparatus of FIG. 3 includes redundant elements as well as non-redundant elements. Active elements 310, 320 represent redundant elements. One of the elements is in a standby mode while the other is active. The apparatus provides fail-over capabilities so that the standby processor can assume active status and responsibility for the services provided by the former active processor. In such a case, the formerly active processor is placed into a standby mode or a disabled mode until the event that caused the fail-over is resolved.

Elements 330-360 provide the interface to the physical media carrying the communications. In one embodiment, elements 330-360 are referred to as line cards. Although multiple (n) line cards 330-360 are illustrated, the line cards are not provided with redundancies in this embodiment.

For router nodes, elements 330-360 might be referred to as “data plane” elements while elements 310 and 320 are referred to as “control plane” elements. The data plane examines the destination address or label and sends the packet in the direction and manner specified by a routing table. The control plane describes the entities and processes that update the routing tables. In practice, elements 310 and 320 may include some data plane functions or associated hardware such as a switch matrix. Similarly, elements 330-360 may include some aspects of a control plane.

Processors 314 or 324 may be responsible, for example, for modifying or updating routing tables utilized by the processors of elements 330-360. Lower level processors such as processor 334 are responsible for configuring even lower-level hardware such as hardware 336. Hardware 336 might be a field programmable gate array (FPGA) or an application-specific integrated circuit (ASIC), for example.

Each processor throughout the hierarchy requires a set of processor-executable instructions that determine the implementation of a particular protocol layer by that processor. The processor-executable instructions may be embodied as “software” or “firmware” depending upon the storage medium or the method used to access these instructions. Generally the term software will refer to “processor executable instructions” regardless of the storage medium or the method of access, unless indicated otherwise.

Occasionally the network component must be upgraded to handle new protocols, expansions to existing protocols, or new or changed features. Although hardware upgrades (i.e., replacement of processors) might be required, typically the component can be upgraded through software upgrades. Although different versions of software 312, 322, 332 may reside with the storage medium associated with a particular processor 314, 324, and 334, respectively, an upgrade or change is not effective until the processor has loaded and is executing the desired version. Thus mere storage of a particular version is not sufficient to effect an upgrade or modification. Typically the processors must be reset or re-booted to load a different version of the software.

Software upgrades necessarily disrupt the functioning of the associated processor. Upgrading or modifying the software associated with a processor renders the processor unavailable and effectively nonfunctional throughout the upgrade. Accordingly, the processor cannot perform its intended functions during the upgrade. The apparatus as a whole cannot fully implement the layered protocol as long as any hierarchy is nonfunctional due to the upgrading of its processor. Outages or loss of service of the apparatus as a whole for even a few minutes may be extremely costly thus the amount of time that the apparatus is nonfunctional should be minimized.

One approach is to upgrade the software of all the processors at the same time. Although this can minimize the total amount of time required for the upgrade, this approach is also likely to render the entire apparatus effectively nonfunctional throughout the entire upgrade process thus incurring a large penalty as a result of unavailability.

An alternative staggered upgrade approach staggers the upgrades across the hierarchical levels. This approach requires more time to perform the upgrade of all the software, however, much of the functionality of the apparatus is preserved throughout the upgrade process. In particular, the functioning of an individual layer is substantially preserved while upgrading the software associated with higher protocol layers. When necessary, a layer is transferred from the processor normally handling that layer to a processor at a different hierarchical level in order to preserve some, if not all, of the functionality of the transferred layer during the upgrade of the software associated with the normal processor. Preferably, the data traffic “status quo” should be preserved while upgrading the software.

Prior to execution of the upgrade, the appropriate version of target software is downloaded for each processor. The software may be stored in nonvolatile memory or a non-volatile memory. In one embodiment, the target version software is downloaded to a random access memory local to the associated processor. Typically, the software required for processors at the same hierarchy level will be the same. The software required for a processor at one level is not, however, typically the same as the software required for a processor at a different level because of the different functions performed at the different levels. The downloading process does not impact data traffic.

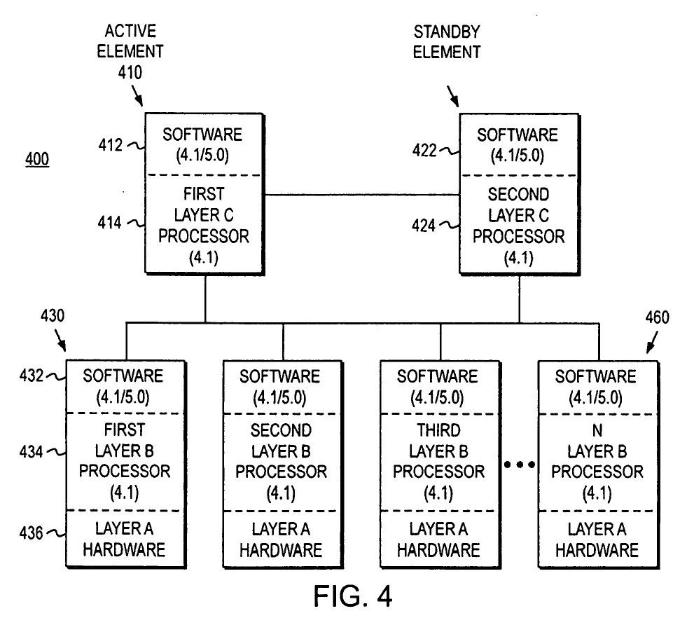

FIGS. 4-10 illustrate this upgrade process graphically for upgrading a node 400 from a starting version (4.1) to a target version (5.0) of software. FIG. 4 illustrates the version status of software stored and used by the elements after first downloading the target version. After the download, both the starting version and the target version of software are present for each element. Thus software 412, 422 includes version 4.1 and 5.0 appropriate for processors 414 and 424. Similarly, elements 430-460 have versions 4.1 and 5.0 of the software 432 appropriate for the respective processor 434. The hardware associated with some layers such as the Layer A hardware 436 may only require the re-programming of registers with new values to implement the desired changes for that layer. The active element 410 controls the upgrade process until the point at which element 410 must be upgraded.

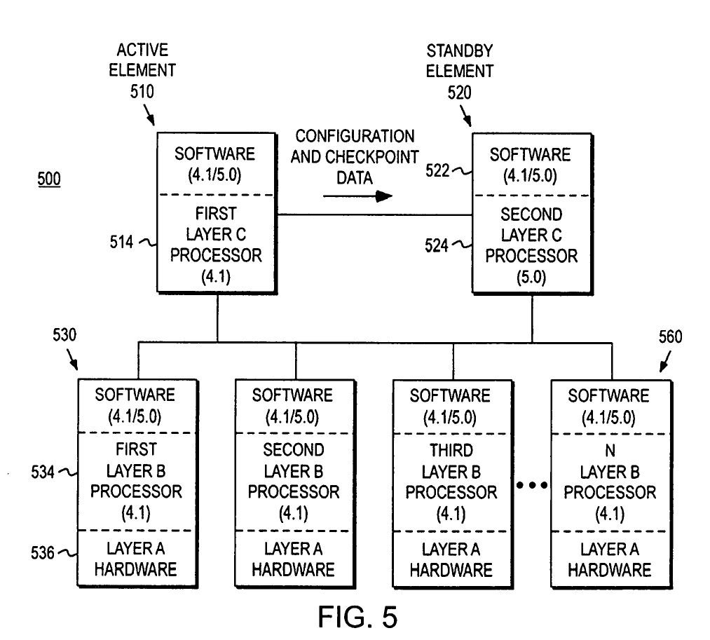

Referring to FIG. 5, the software 522 associated with the standby element 520 is updated first. This is accomplished by performing a soft reset of processor 524 with the boot vector directed to the target version of the software. After the soft reset, standby element 520 is executing the target version of the software. The standby element attempts to synchronize with the active element. The standby element retrieves configuration information and checkpoint data from the active element for synchronization. The standby element stores information using the updated version of any database as dictated by the target version of the software. Although the node is vulnerable due to the lack of full redundancy, this update has no impact on lower level layers handling data traffic such as the Layer A hardware 536 for elements 530-536.

If an update of the redundant elements is the only update required, then fail-over mechanisms can be used to update the active elements. Using existing fail-over protocols, the active/standby status of the two elements 510, 520 can be swapped and a soft reset can be performed on processor 514 similar to that previously performed on processor 524. When more than one level must be updated, however, the upgrade process proceeds to update lower levels before completely updating the current level. This allows the apparatus 500 to return to the starting version in the event of a failure in the upgrade process.

Although the next lower level of the hardware hierarchy includes several processors 534, these processors are not configured to provide redundancy. Thus performing a soft reset on these processors may terminate connections or sessions requiring Layer B functionality. Layer B might provide, for example, “keep alive”, “hello” or other connection maintenance functionality such as that found in layer 3 of the OSI model. Such connection maintenance functionality may be required to support various protocols and connections including the Intermediate System-to-Intermediate System (IS-IS) and Open Shortest Path First routing protocols, label switch paths (LSP), etc. If this functionality is absent, one or more connections or sessions will be terminated despite the ability of lower level layers to otherwise continue to forward packets. Failure to provide this functionality will result in the loss of various connections and sessions.

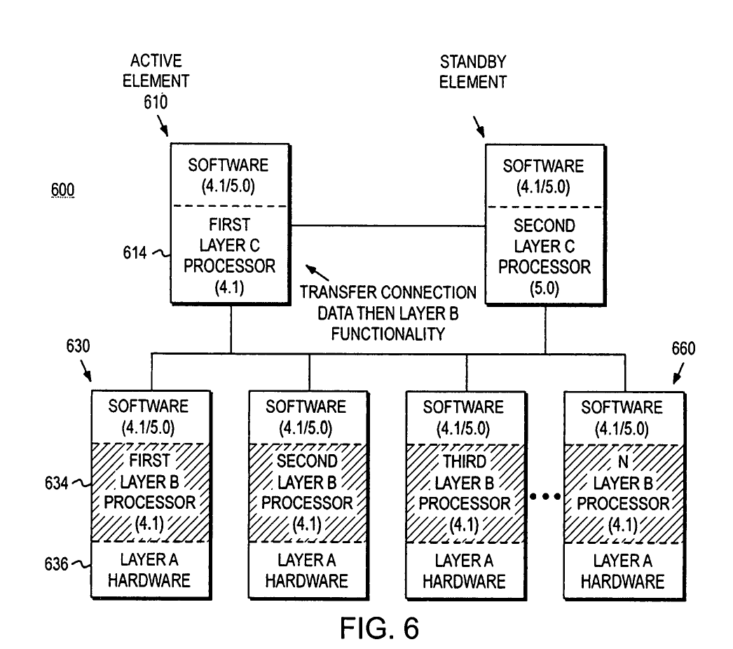

Referring to FIG. 6, Layer B is moved from the processor 634 at one hierarchical level to a processor 614 at a higher hierarchical level. The layer is thus moved to another processor for handling. Processor 614 reads the connection data from elements 630-660 prior to the transfer. Connection data includes both the static configuration information as well as the dynamic state information regarding the types of interfaces and protocols executing on those interfaces.

Layer B is then transferred from the processors 634 of elements 630-660 to processor 614. Processor 614 of active element 610 executes program code supporting Layer B functionality with the initial conditions established by the connection and configuration information read from elements 630-660. This is equivalent to moving the control plane from one processor to another processor at a different location in the processor hierarchy.

After Layer B functionality is transferred, a soft reset is performed on the processors 634 normally associated with Layer B processing. The boot vector is directed to the target version of the software. This activity does not disrupt the data traffic handled by the Layer A hardware of elements 630-660.

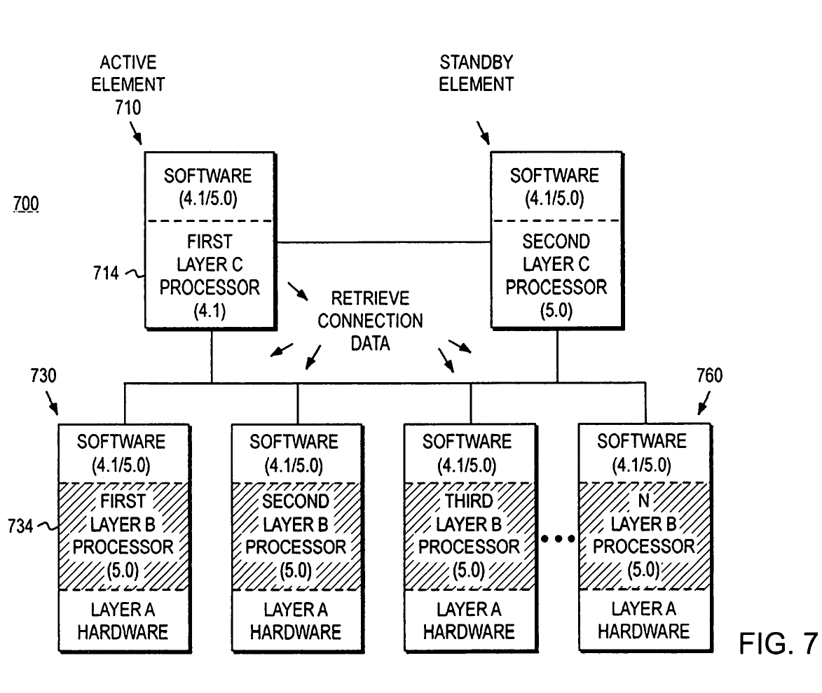

FIG. 7 illustrates the communication apparatus 700 after the soft reset. Processor 734 of elements 730-760 are executing the target version (5.0) of the software. Processor 734 of elements 730-760 then retrieves the connection data associated with Layer B from the hierarchically higher processor 714 of active element 710.

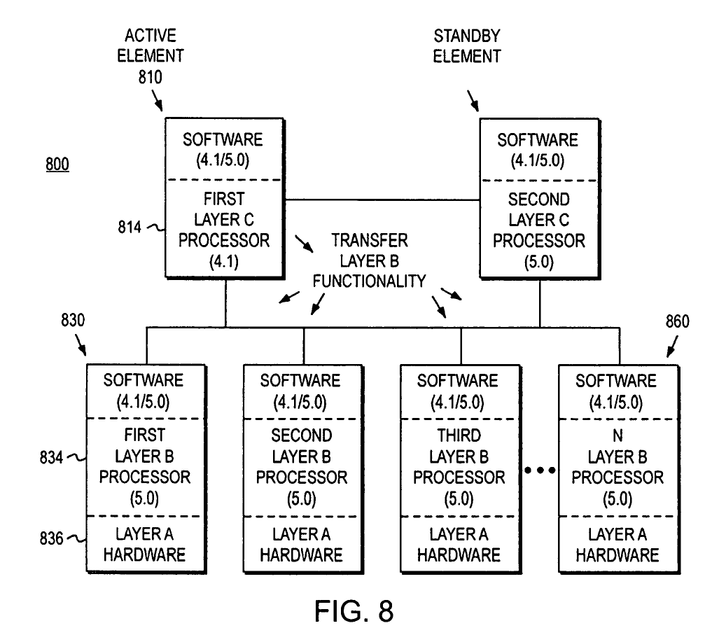

FIG. 8 illustrates the transfer of Layer B functionality back to the processors of elements 830-860 of node 800. Processor 814 stops executing program instructions associated with Layer B. The processor 834 of elements 830-860 begin executing Layer B program code using the connection data retrieved from active element 810. Processors 834 of elements 830-860 handle the control plane for the Layer A hardware 836. Thus the control plane is restored to the elements normally associated with Layer B functionality. The transfer does not disrupt the data traffic handled by the Layer A hardware 836 of elements 830-860.

The Layer A hardware must be updated to support the various protocol changes resulting from the software update. Reconfiguration of the Layer A hardware necessarily disrupts the traffic handled by the Layer A hardware, however, the reconfiguration primarily entails writing values to registers of low level hardware such as ASICs. Instead of disrupting Layer A functionality throughout the upgrade of the node, Layer A functionality is disrupted only for the relatively short period of time required to reconfigure the low-level hardware. In contrast to the update procedure for the higher level processors, reconfiguration of low level hardware such as ASICs is on the order of fractional seconds to seconds.

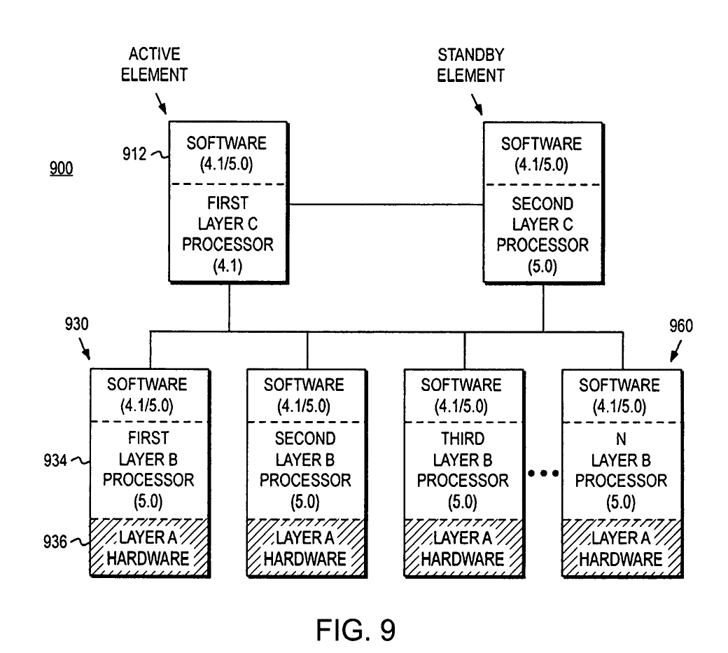

FIG. 9 illustrates reconfiguring the Layer A hardware 936 of elements 930-960 for node 900. Processors 934 configure their respective Layer A hardware 936 to support the functionality determined by the software upgrade.

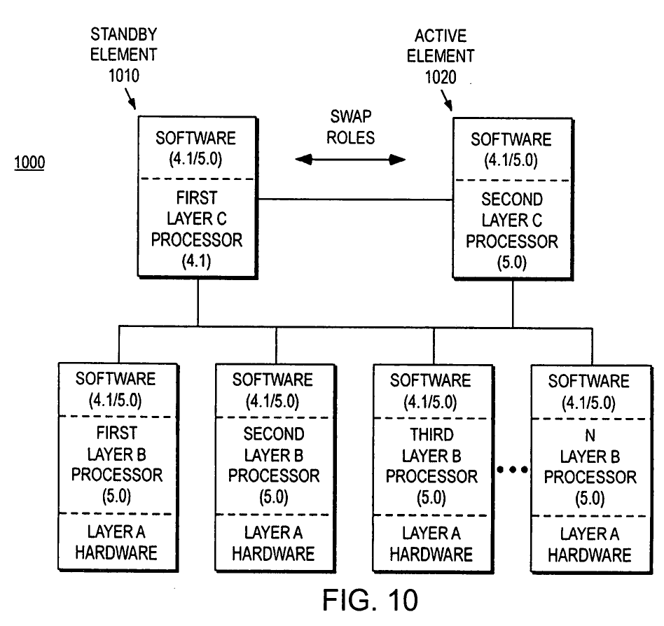

In order to finish the upgrade process, software 912 can be updated using typical fail-over mechanisms to avoid disruption. Referring to node 1000 of FIG. 10, the active and standby status of elements 1010, 1020 is swapped such that element 1010 is now in standby mode and element 1020 is the active element. Active element 1020 assumes control for the remainder of the upgrade process.

FIG. 11 illustrates the result of a soft reset of processor 1114 using a boot vector pointing to the target version of the software 1112. After the soft reset, processor 1114 is executing the target version of the software. Standby element 1110 then retrieves configuration and checkpoint information from active element 1120 in order to synchronize with active element 1120. The upgrade of the software at this level of the hierarchy does not disrupt the data traffic handled by the Layer A hardware 1136.

Booting any of the processors using the target version of the software might take considerable time, however, the functionality of the processors has been “covered” either through redundancy or by moving layer support to a processor at a different level in the hierarchy. The time required to transfer a control plane back and forth between hierarchical levels is very short compared to the time required to complete the upgrade and bring the processors online with the target version of software. Such transfer does not disrupt the data traffic handled by the Layer A hardware 1136.

Since Layer C elements are not executing the same version of the software until the upgrade is complete, there is a loss of redundancy protection throughout the duration of the upgrade process. In addition, the static component of the Layer B connection data (i.e., the configuration data) is not permitted to change throughout the upgrade of the software associated with Layer B. For a router, this could imply that alarms, requests to establish/terminate connections, and routing table updates/modifications are ignored. Network components external to node 1100 may terminate connections, for example, but the termination will not be recognized by node 1100 until the upgrade has completed and the termination has been subsequently detected by node 1100.

Thus some functionality is lost during the upgrade process, however, the traffic moving capabilities having the greatest impact on availability are maintained throughout the upgrade process. The layered protocols are typically robust and they permit node 1100 to re-detect conditions that were ignored during the upgrade process in the event that such conditions were not resolved prior to the completion of the software upgrade.

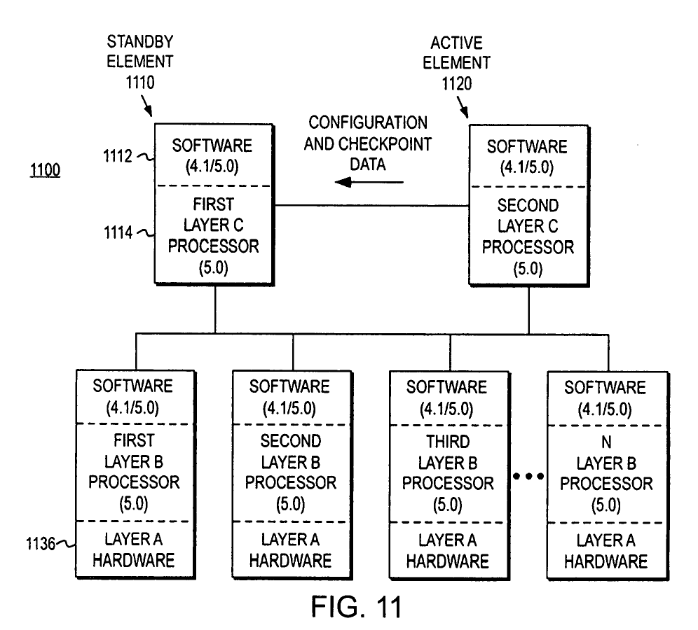

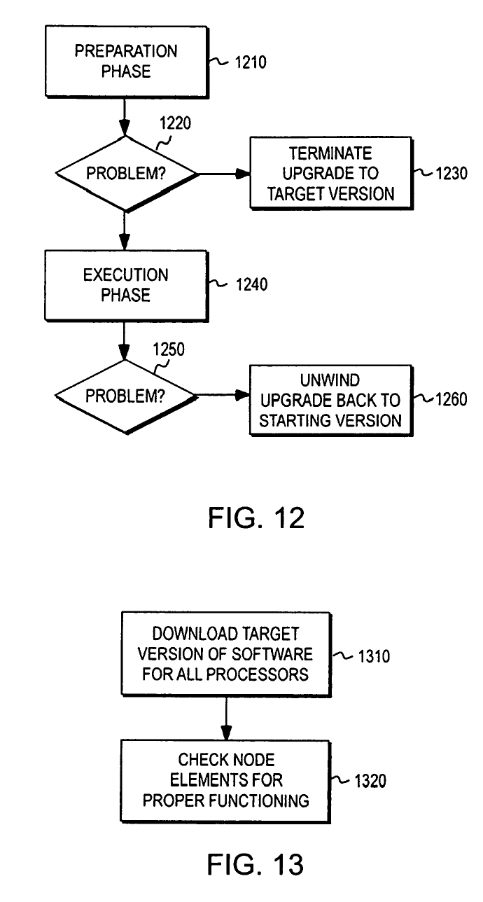

To reduce the risk of failure in the upgrade process, the upgrade process is performed in two phases: a preparation phase and an execution phase as indicated in FIG. 12. The preparation phase is performed in step 1210. If problems are discovered in the preparation phase as determined by step 1220, the upgrade to the target version is terminated in step 1230. Otherwise, the upgrade process continues with the execution phase in step 1240. If problems are discovered during the execution phase as determined by step 1250, the upgrade process is “unwound” to the starting version of the software in step 1260.

FIG. 13 illustrates one embodiment of the preparation phase. In step 1310, the target version of the software is downloaded to memory for each processor in the element hierarchy that needs to have its associated software upgraded. The starting version may be preserved to enable restoration to the starting version of the software in the event of a failure in the upgrade process.

In step 1320, the node is checked to ensure that all elements are functioning properly. The preparation phase cannot complete successfully unless all elements have full operational functionality. The determination of operational functionality might include checking whether the node has operational redundancy, whether all elements are working, and whether any element is in a transitional state (e.g., being reset, updated, etc.).

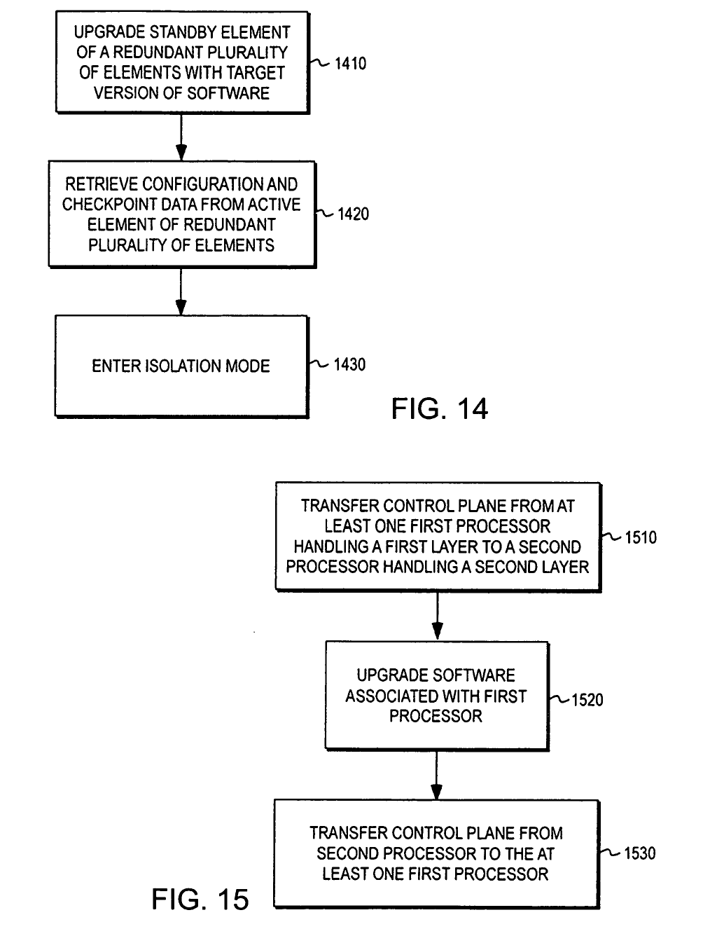

FIG. 14 illustrates one embodiment of the beginning of the execution phase. In step 1410, a standby element of a redundant plurality of elements is upgraded to a target version of software. In one embodiment, this is accomplished by performing the soft reset previously described. In step 1420, the standby element retrieves configuration and checkpoint data from an active element of the redundant plurality of elements. The standby element performs any necessary data conversions required to bring the retrieved data into conformance with the formats dictated by the target version of the software. At this point, the node no longer has redundancy protection.

The node is placed into isolation mode in step 1430 to prevent configuration changes. In the case of a router, for example, alarms, requests to establish/terminate connections, and routing table modifications are ignored.

The software for lower level processors may also be upgraded. As previously indicated, however, layer functionality must be preserved throughout the upgrade. In order to preserve layer functionality, the associated control plane is transferred from a processor at one level of the element hierarchy to a processor at another level of the element hierarchy as indicated in FIG. 15. 20

In step 1510, a control plane is transferred from at least one first processor handling a first layer to a second processor handling a second layer. This is equivalent to transferring the layer or layer portion handled by the first processor to the second processor handling another layer or layer portion. The node may have a single first processor or n first processors such as the processors 434 associated with each of elements 430-460.

The first and second processors are located at different levels of the element hierarchy. Effectively the layer or portion of a layer handled by a first processor is transferred to a second processor at another level of the hierarchy. In contrast to the redundancy approach, all the processors (e.g. 434) handling the first layer or first layer portion prior to the transfer can have a software upgrade at substantially the same time. In contrast the redundancy approach requires swapping the roles of active and standby components such that upgrades for all elements at the same level cannot occur substantially simultaneously.

In step 1520, the software associated with the at least one first processor is upgraded. This may be accomplished by using a soft reset to force the first processor(s) to load the target version of the software as previously described. This upgrade does not impact data traffic handled by lower level layers. In step 1530, the control plane is transferred back to the at least one first processor. The transfer of the control plane does not disrupt the data traffic carried by any lower level layers.

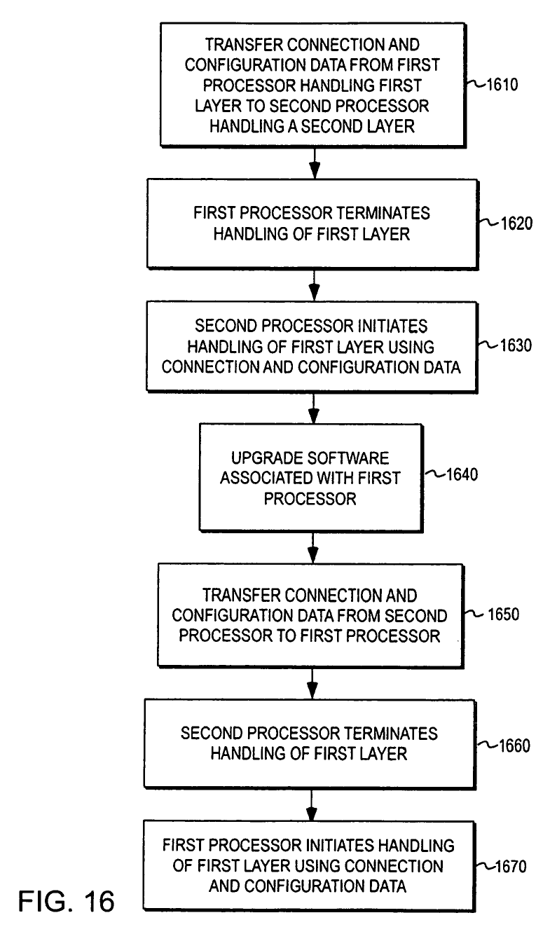

FIG. 16 illustrates the transfer of the control plane or layer functionality in greater detail. In step 1610, a first processor handling a first layer provides connection data (i.e., the static configuration and dynamic state) to a second processor handling a second layer. In step 1620, the first processor terminates handling first layer functions. In step 1630, the second processor initiates handling of the first layer functions using the connection data. Thus a first layer being handled by the first processor is transferred to a second processor handling a second layer.

The software upgrade for the first processor is performed in step 1640. During the upgrade, the second processor is handling first layer functionality. This might include, for example “hello”, “keep alive”, or other functionality required to preserve the status quo with respect to other nodes in the communications network.

After the upgrade, the first processor retrieves the connection data from the second processor in step 1650. The second processor terminates handling first layer functions in step 1660. The first processor initiates handling first layer functions in step 1670 using the connection data. This is equivalent to transferring the first layer being handled by the second processor back to the first processor for handling.

To support the protocol modifications at the data traffic layer, the low level hardware must be re-configured. The connection data preserved throughout the upgrade of the control plane for the low level hardware must be re-mapped or otherwise modified to ensure compatibility with the upgraded versions of the protocols instituted by the software upgrade.

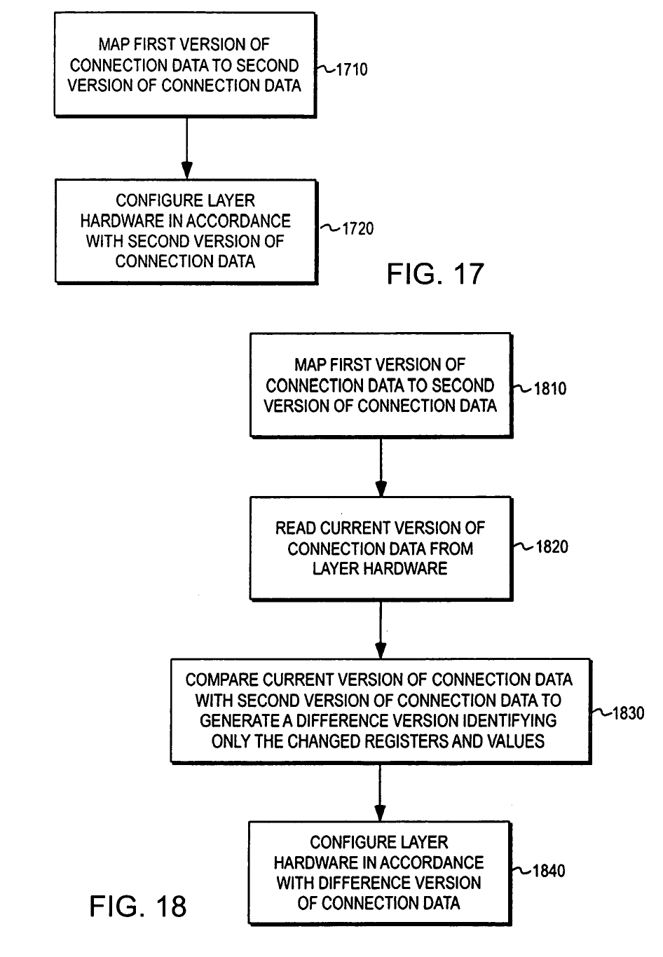

FIG. 17 illustrates one embodiment of re-configuring the low-level hardware. In step 1710, a first version of connection data compatible with a first version of a layer is mapped to a second version of connection data compatible with a second version of a layer. The connection data includes static configuration data as well as dynamic state data. In step 1720, the low-level layer hardware is re-configured in accordance with the second version of connection data. This might entail, for example, writing values to a number of registers. This re-configuration disrupts the data traffic handled by the low-level hardware, but the amount of time required to write values to the registers is on the order of fractions of a second to seconds and thus of sufficiently short period of time to avoid causing other nodes in the communications network from taking corrective action such as re-routing communications around the node being updated.

An alternative approach to re-configuring the low-level hardware can potentially decrease the amount of time required for re-configuration by reducing the number of write operations required. The aforementioned re-mapping operation does not necessarily result in a change in value for every register of the low-level layer hardware. The number of write operations might be significantly reduced if values are written only to the registers that have changed values.

FIG. 18 illustrates one embodiment of the alternative approach to re-configuring the low-level hardware. In step 1810, a first version of connection data compatible with a first version of a layer is mapped to a second version of connection data compatible with a second version of the layer. The first and second versions of the layer refer to the pre- and post-upgrade versions of the layer.

A read operation is performed to retrieve the current version of the connection data from the low-level layer hardware in step 1820. The current connection data is compared to the second version of the connection data to identify a difference (DIFF) version of the connection data in step 1830. The DIFF version identifies only the registers that have changes in value and what those values should be. The DIFF version thus identifies only the locations that actually require a change. The low-level hardware is then re-configured in accordance with the difference version of the connection data in step 1840. The difference version can potentially decrease the amount of time that the data traffic is disrupted by eliminating the time spent writing to registers that do not require changes.

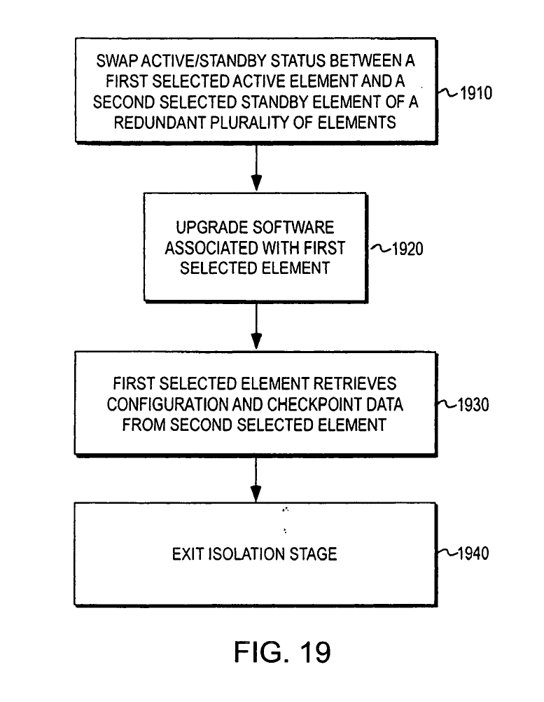

The remaining elements of the redundant plurality of elements may now be upgraded as indicated in FIG. 19. Until this point the upgrade process has been controlled by the active element of the redundant plurality of elements. A first selected active element swaps active/standby status with a second selected standby element in step 1910. The first selected element is now a standby element and the second selected element is now the active element. The second selected element is now responsible for controlling the remainder of the upgrade process.

The first selected element is upgraded to a target version of the software in step 1920. This may be accomplished, for example, by performing a soft reset of the processor with a boot vector directed to the target version of the software. In step 1930, the first selected element retrieves configuration and checkpoint data from the second selected element.

At this point the redundant plurality of elements are synchronized and capable of providing redundancy protection. The node exits isolation mode in step 1940 to enable configuration changes.

Methods and apparatus for modifying a layered protocol communications apparatus have been described. For example, software is updated for different layers without disrupting lower layer data traffic. In particular functionality is preserved for a layer either by providing a redundant element to handle the layer or by transferring the layer to an element at a different hierarchical level of the layered protocol hierarchy.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

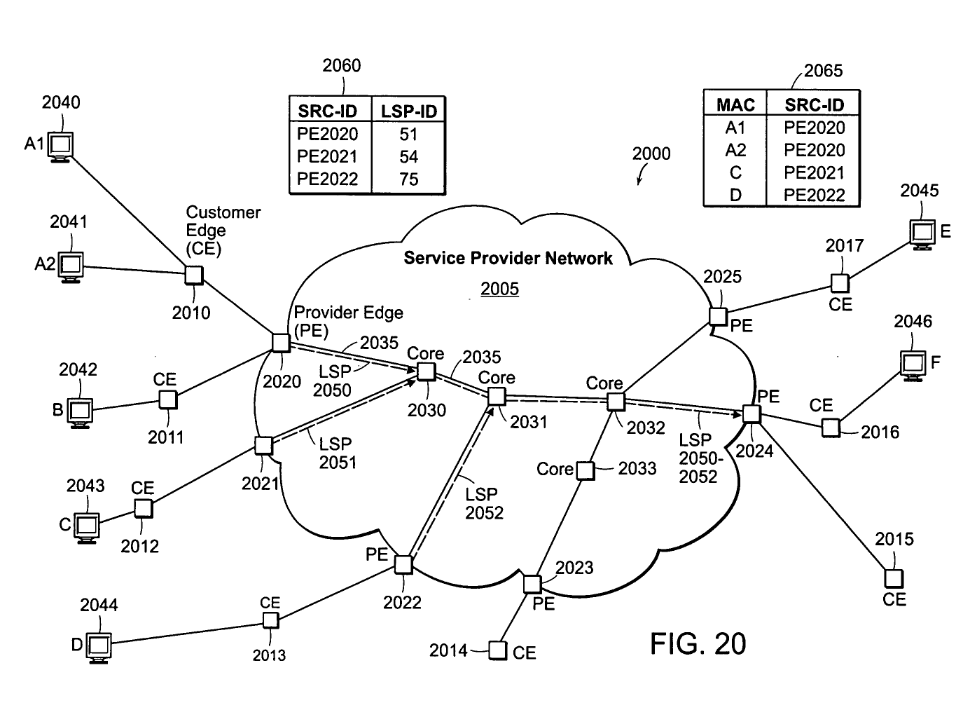

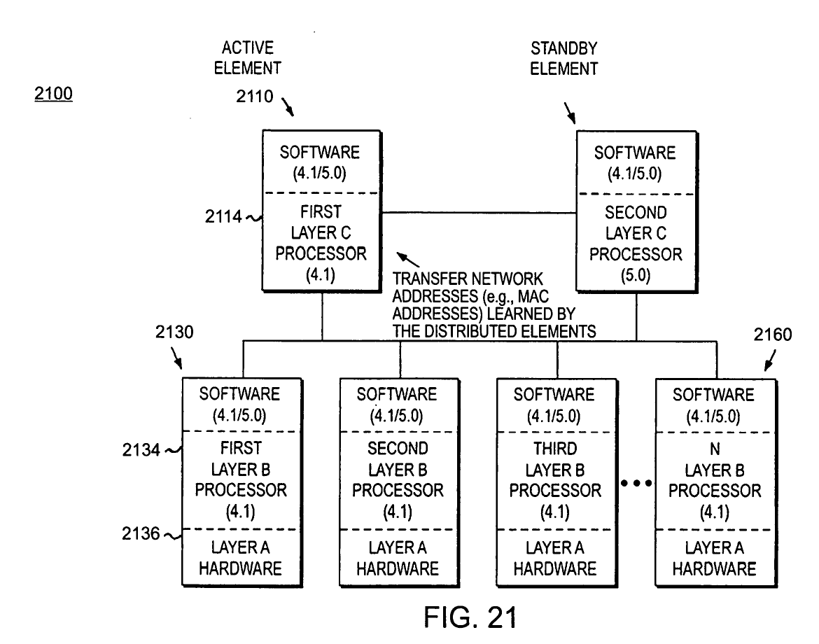

FIG. 20 is a network diagram illustrating a network 2000 in which Medium Access Control (MAC) addresses are learned. The network 2000 includes provider edge routers (PEs) 2020-2025 and core routers 2030-2033, which are interconnected by communications links 2135, such as wire, wireless, or optical links. Customer edge routers (CEs) 2010-2017 route communications from end user nodes 2040-2046 to the service provider network 2005. In the example network, Multi-Protocol Label Switching (MPLS) is used in the service provider network 2005 to support communications between source and destination nodes (i.e., end user nodes 2040-2046). Label Switched Paths 2150-2152 may be established within the service provider network 2005.

A PE associated with a destination node (e.g., node F 2046) learns a source MAC address of the original sender of a packet received by the PE via the LSP and associates that MAC address with the ingress PE by which it entered and was sent through the LSP. A source identifier (src_id) can be appended to a header of a data packet or frame at an ingress PE, such as by adding the src_id as an additional label at the bottom of an MPLS label stack. Upon receipt by an egress PE, the src_id is used to associate (i) the MAC address for the source station that originated the packet (e.g., the MAC address for the CE (e.g., CE 2010)) for a packet sent by station A1 2040 with (ii) the ingress PE by which it entered and was sent through the LSP 2150.

A first table 2060 can be used to map src_id's to associated LSP identifiers (LSP_IDs) for a particular LSP or Virtual Private Network (VPN), for example, and a second table 2065 can be used to associate source MAC addresses with corresponding src_id's. Using these tables 2060, 2065, a PE can determine where to send packets between source and destination nodes 2040-2046 very quickly rather than having to broadcast messages to make the determination, as is known in the art.

FIG. 21 is a block diagram of a system 2100 that learns network data (e.g., addresses, such as MAC addresses) in each of the Layer B processors 2134 of each of the distributed components or elements (e.g., line cards) 2130-2160 in a distributed manner. In a Multi-Protocol Label Switching (MPLS) environment or other network protocol environment, Virtual Private Local Area Network (LAN) Services (VPLS) or the like create a situation in which network addresses beyond Internet Protocol (IP) addresses and hardware addresses are learned by intermediary network nodes. Thus, preservation of the learned network addresses, such as MAC addresses, across a reboot of distributed Layer B processors 2134 that learn the network addresses in a distributed manner is useful so that the addresses do not have to be relearned, which creates unnecessary network delay, according to an embodiment of the invention.

Referring to FIG. 21 in view of the foregoing, in a situation distributed Layer B processors 2134 each learn MAC addresses, for example, in a typical manner through servicing network communications from source nodes to destination nodes (not shown) along a network path (not shown), the Layer B processor (i) takes advantage of a Layer C processor, which is uninvolved with learning the MAC addresses in the distributed learning environment, by passing the MAC addresses to the Layer C processor prior to a reboot, (ii) reboots, and (iii) retrieves the MAC addresses after the reboot.

The distributed learning environment is different from a centralized MAC learning environment in that, in the centralized learning environment, the Layer C processor 2114 knows about the MAC addresses, a situation similar to connection data known to the Layer C processors as described above in reference to FIGS. 6 and 7. In a centralized learning environment, the Layer C processor 2114 has MAC-related processing, such as learning/aging/refreshing, but does not perform such functions in the distributed learning environment, nor does the Layer C processor 2114 send any information to the Layer B processors 2134 during a normal initial synchronization. Thus, in a centralized learning environment, MAC data is preserved across reboots of Layer B processors 2134 based on its centralized construct.

However, in distributed learning environments, it is assumed that the Layer B processors 2134 have to re-learn the MAC addresses (or other network addresses) through the course of servicing future communications between source and destination nodes. According to an embodiment of the invention, learned MAC addresses can be preserved across reboots of the Layer B processors 2134 through coordinated assistance from the Layer C processor 2114. It should be understood that another component (e.g., processor, memory, etc.) in the network node or external from the network node in which the Layer B and C processors operate may alternatively be employed to assist in the preservation of the network addresses (e.g., MAC addresses). Further, through the Layer B processor 2134 reboot process, the Layer A hardware 2136 continues to support network communications.

It should be understood that the MAC addresses, or other learned network addresses, can be transferred from the Layer B processors 2134 to the Layer C processor 2114 on an as-learned basis or immediately prior to a reboot. Moreover, transferring the learned MAC addresses can be done on an individual address basis or in the form of transferring a database containing the MAC addresses.

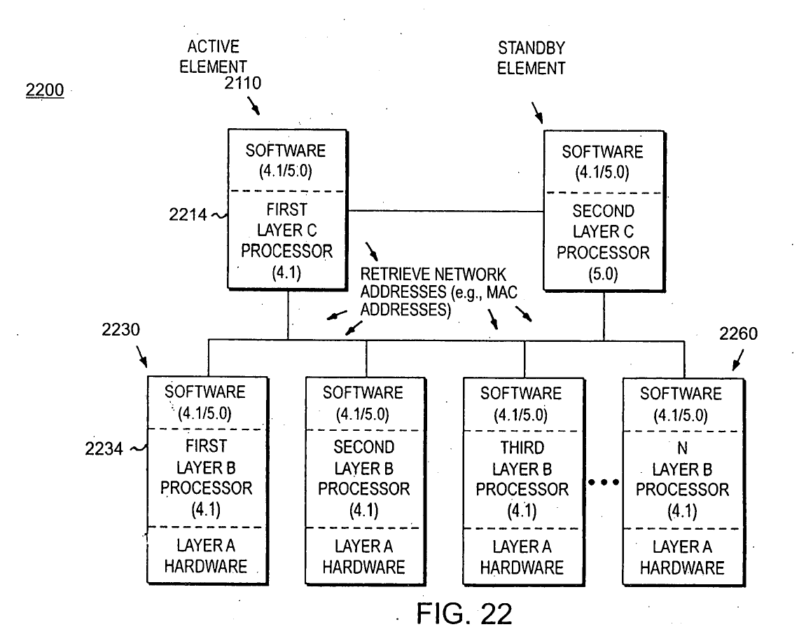

FIG. 22 is a block diagram illustrating retrieval of the network addresses (e.g., MAC addresses) by Layer B processors 2234 from the Layer C processors 2214 in a distributed learning configuration of elements 2230-2260 in which the Layer B processors 2234 are deployed. The retrieval of network addresses occurs after the Layer B processors 2234 are rebooted.

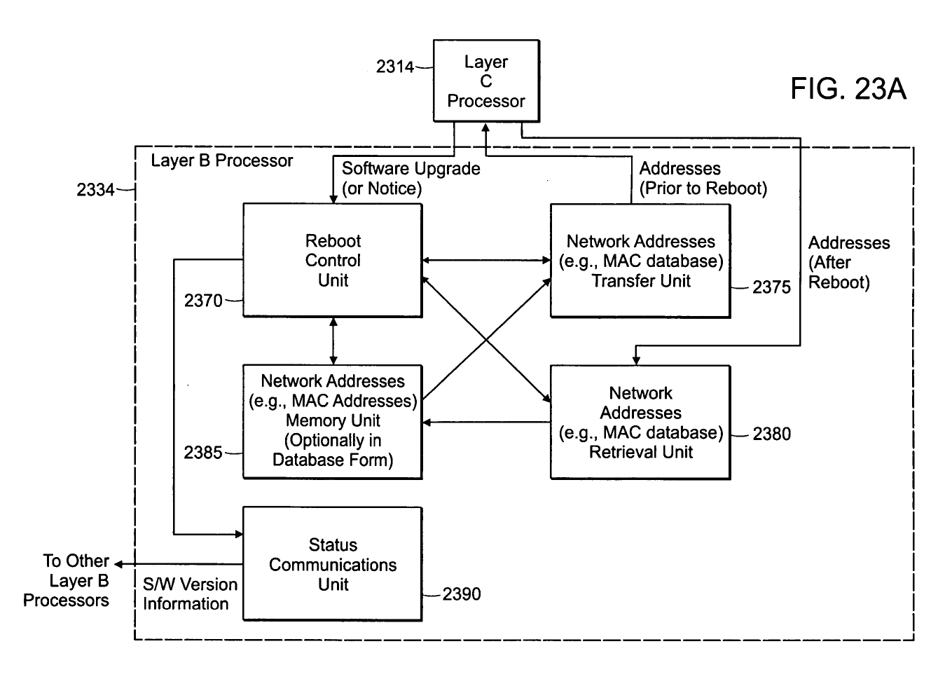

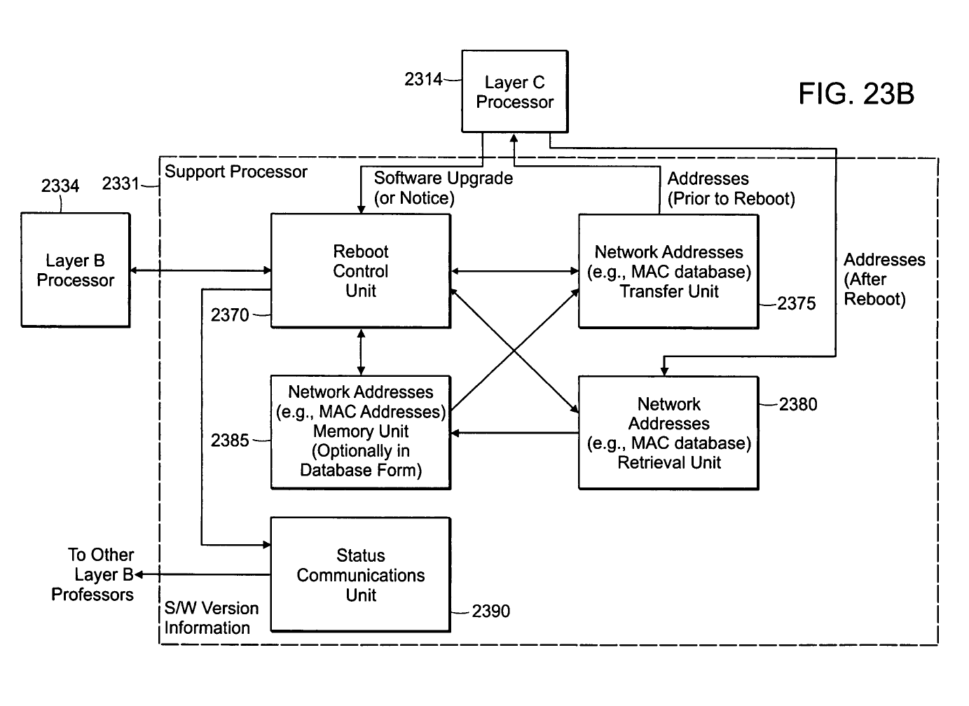

FIGS. 23A and 23B are a block diagrams illustrating an example configurations in a Layer B processor 2334 (FIG. 23A) or in a support processor 2331 (FIG. 23B) associated with the Layer B processor 2334. The example configurations may be implemented in the form of hardware, firmware, or software units. In the example embodiments, the Layer B processor 2334 (FIG. 23A) or support processor 2331 (FIG. 23B) may include a reboot control processor 2370, network addresses transfer unit 2375, network addresses retrieval unit 2380, MAC addresses (or other network addresses) memory unit 2385, and a status communications unit 2390. In other embodiments, other units may be employed, the units may be subdivided, grouped together, fewer units may be used, or so forth.

One reason the Layer B processors may be rebooted is to upgrade their software. As indicated, a Layer C processor 2314 downloads a software upgrade, or sends notice of a software upgrade transfer to an associated Layer C processor, to the reboot control unit 2370. Responsively, the reboot control unit 2370 may cause the network addresses transfer unit 2375 to transfer addresses to the Layer C processor 2314 prior to the reboot. Following the transfer, in this embodiment, the reboot control unit 2370 causes the Layer B processor 2334 (FIG. 23A) or Layer B processor 2334 and/or support processor 2331 (FIG. 23B) to reboot. After the reboot, the reboot control unit 2370 causes the network addresses retrieval unit 2380 to retrieve addresses from the Layer C processor 2314 to restore them for future use for VPLS support or support of other services.

After the reboot occurs, the reboot control unit may cause the status communications unit 2390 to send software version information to other Layer B processors (not shown) or the Layer C processor 2314 to inform them that the software is now upgraded (e.g., from version 4.1 to version 5.0). The software version information may be useful in systems where the former and upgraded versions of the software are incompatible. The Layer B processors 2334 are typically not upgraded simultaneously, so the status communications unit 2390 issues the software version information as a safeguard to prevent system lock-up due to software version incompatibility. Other types of handshaking techniques between the Layer C processor 2314 and Layer B processor 2334 or among multiple Layer C processors 2314, optionally supported by support processors 2331, can be used to ensure communications are restricted during an upgrade cycle of the Layer B processors 2334. ‘Status ready,’ ‘acknowledge,’ or ‘upgrade finished’ messages are examples of messages that can be used in such handshaking scenarios and used in accordance with whatever communications protocol is employed between or among the components (i.e., Layer B processor and Layer C processors).

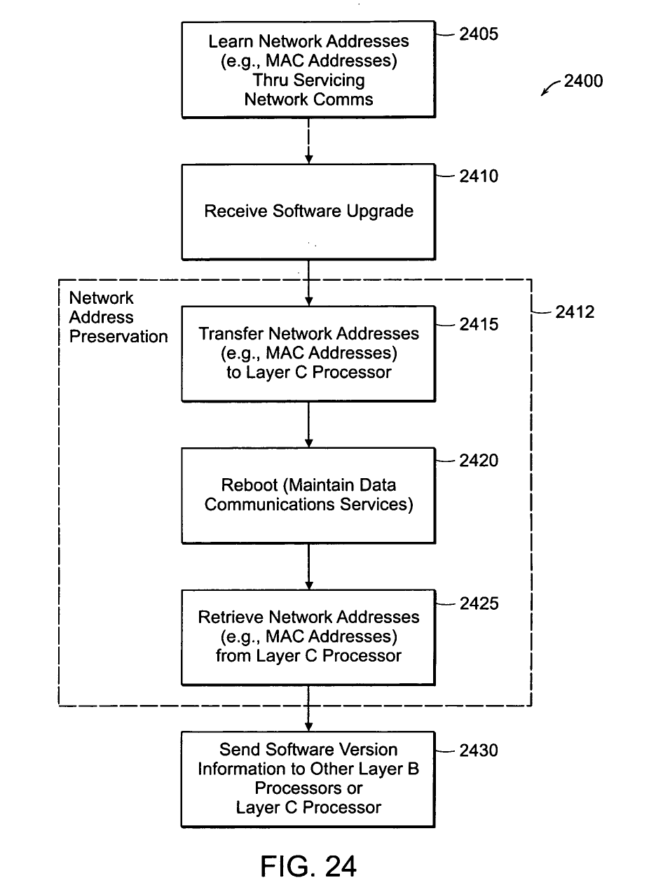

FIG. 24 is a flow diagram 2400 illustrating an embodiment of the invention. In this embodiment, network addresses (e.g., MAC addresses) are learned (2405) through servicing network communications, such as VPLS communications. Sometime later, a software upgrade may be received (2410), and network address preservation (2412) may thereafter be employed. The learned network addresses are transferred (2415), optionally in the form of a database if that is how the network addresses are stored, to a component (e.g., Layer C processor, off-processor memory, etc.) that is not being rebooted. A reboot (2420) of the Layer B processor occurs, optionally while maintaining data communications services, which causes the Layer B processor to lose the learned network MAC addresses (e.g., MAC addresses). The network addresses are thereafter retrieved (2425) from the component to which the network addresses were transferred, thus preserving the learned network addresses across the reboot. In this embodiment, the rebooted Layer B processor sends (2430) software version information to other Layer B processors or the Layer C processor to inform them that it is operating with the upgraded software.

It should be understood that the flow diagram 2400 can be implemented in software stored on a computer-readable medium and loaded and executed by a processor. The computer-readable medium may be RAM, ROM, CD-ROM, or any other type of computer readable medium. The processor may be a general purpose or application-specific processor configured to operate in the environments described herein.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of preserving network addresses across a reboot, the method comprising:
learning network addresses, associated with sources and destinations of network communications, in a distributed manner on a network path between the sources and destinations;
transferring the network addresses prior to a reboot of a process involved with learning the network addresses;
rebooting the process; and
retrieving the network addresses after the reboot to preserve the network addresses across the reboot.

2. The method according to claim 1 wherein transferring the network addresses includes transferring Medium Access Control (MAC) addresses.

3. The method according to claim 2 wherein transferring the MAC addresses includes transferring a MAC database.

4. The method according to claim 1 wherein transferring and retrieving the network addresses includes transferring and retrieving the network addresses between processes operating on different layers of a network communications model.

5. The method according to claim 1 further including supporting passage of the network communications during the reboot.

6. The method according to claim 1 further including upgrading the process by rebooting the process.

7. The method according to claim 6 wherein upgrading the process includes transferring a software upgrade prior to the reboot and effecting the upgrade by rebooting the process.

8. The method according to claim 1 further including communicating a status of the process at least after the reboot.

9. An apparatus for preserving network addresses in a network node across a reboot, the apparatus comprising:
distributed components in a network node on a network path between source and destination nodes, the distributed components (i) learning network addresses in the course of facilitating communications to traverse the network path from the source nodes to the destination nodes and (ii) losing the network addresses in an event of a reboot of the distributed components; and
at least one other component in the network node, uninvolved with learning the network addresses, to which the distributed components transfer the network addresses prior to a reboot and from which the network addresses are retrieved by the distributed components following the reboot.

10. The apparatus according to claim 9 wherein the network addresses are Medium Access Control (MAC) addresses.

11. The apparatus according to claim 10 wherein the MAC addresses are stored in a MAC database and the distributed components transfer the MAC addresses to the at least one other component and retrieve the MAC addresses from the at least one other component by transferring the MAC database.

12. The apparatus according to claim 9 wherein the distributed components are line cards and the at least one other component is a management component or a routing component.

13. The apparatus according to claim 9 wherein the distributed components support passage of the network communications during the reboot.

14. The apparatus according to claim 9 wherein the distributed components are upgraded by the reboot.

15. The apparatus according to claim 14 wherein the at least one other component transfers a software upgrade to the distributed components prior to the reboot.

16. The apparatus according to claim 9 wherein each distributed component communicates a status to each other distributed component or the at least one other component at least after the reboot.

17. A computer-readable medium having stored thereon sequences of instructions, the sequences of instructions including instructions, when executed by a digital processor, that cause the processor to perform:
learning network addresses associated with sources and destinations of network communications on a network path between the sources and destinations in a distributed manner from other processors also learning network addresses;
transferring the network addresses prior to a reboot of the processor;
rebooting the processor; and
retrieving the network addresses after the reboot to preserve the network addresses across the reboot.

18. The method according to claim 17 wherein transferring the network addresses includes transferring Medium Access Control (MAC) addresses.

19. The method according to claim 18 wherein transferring the MAC addresses includes transferring a MAC database.

20. The method according to claim 17 wherein transferring and retrieving the network addresses includes transferring and retrieving the network addresses between processors operating on different layers of a network communications model.
